(19) United States
(12) Patent Application Publication
(10) Pub. No.: US 2006/0058990 A1
(43) Pub. Date: Mar. 16, 2006

(54) Structuring, storing and processing of data according to a generic object model

(76) Inventors: Marcus Burgel, Heroldsberg (DE); Edgar Frank, Nurnberg (DE); Rainer Heller, Eckental (DE); Heinrich Kulzer, Nurnberg (DE)

Correspondence Address: Siemens Corporation;Intellectual Property Department, 170 Wood Avenue South, Iselin, NJ, 08830, US

(21) Appl. No.: 10/532,738

(22) PCT Filed: Oct. 17, 2003
(86) PCT No.: PCT/DE03/03452

§ 371 Date: Apr. 26, 2005

(30) Foreign Application Priority Data
Oct. 30, 2002 (DE) 102 50 638.8

(51) Int. Cl. G06F 9/45

(52) U.S. Cl. 703/22

(57) ABSTRACT

System and method for structuring, storing and processing of data in accordance with a generic object model, with the object model featuring at least one first element which corresponds to the type Object, with the type Object having the following attributes: a unique identification of the object for absolute referencing of the object, a logical name to label the object, and at least one link to a second element, which corresponds to a type Feature, with the type Feature having the following attributes: a unique name in relation to the relevant linked object referenced and the option of linkage to further components of type Object, to further components of type Feature and to data.

### CROSS REFERENCE TO RELATED APPLICATIONS

This application is the US National Stage of International Application No. PCT/DE2003/003452, filed Oct. 17, 2003 and claims the benefit thereof. The International Application claims the benefits of German application No. 10250638.8 filed October 30, 2002, both applications are incorporated by reference herein in their entirety.

### FIELD OF THE INVENTION

The invention relates to a system as well as to a method for structuring, storing and processing of data.

### SUMMARY OF THE INVENTION

Usually a very wide-diversity of software applications are used to deal with technical task definitions, e.g. the engineering of an automation system, with each of these software applications on the one hand performing specific technical tasks and on the other hand interworking with other software applications to handle a technical task. The latter implies that the software applications exchange data over interfaces. The interfaces which the individual software applications provide as well as the data transported over these interfaces are mostly very heterogeneous and proprietary. As a rule the data to be transported will be structured to meet the individual requirements of the data exchange. However, across different software applications this results in incompatible exchange structures.

The object of the invention is to simplify the exchange of data between different software applications.

This object is achieved by a system for structuring, storing and processing of data in accordance with a generic object model, where the object model features at least one first element which corresponds to a type Object, with the type Object having the following attributes:

a unique identification of the object for absolute referencing of the object,

a logical name to label the object and

at least one link to a second element, which corresponds to a type Feature, with the type Feature having the following attributes:
a unique name in relation to the relevant linked object referenced and
   the option of linkage to further components of type Object, to further components of type Feature and to data.

This object is achieved by a method for structuring, storing and processing of data in accordance with a generic object model, with the object model featuring at least one first element which corresponds to the type Object, with the type Object having the following attributes:

a unique identification of the object for absolute referencing of the object,

a logical name to label the object and

at least one link to a second element, which corresponds to a type Feature, with the type Feature having the following attributes:
a unique name in relation to the relevant linked object referenced and
   the option of linkage to further components of type Object, to further components of type Feature and to data.

The invention is based on the idea of describing and structuring complex, preferably hierarchically-structured, data sets with a uniform object model. All elements of the type Object have the same basic structure but can be used at different levels of granularity. The structure of a superordinate element of type Object is thus reflected in the structure of a subordinate element of type Object. The entire object model thus has an almost fractal structure right down to its lowest level. The data sets are structured by replication of a few basic patterns and basic structures. This principle of representation (Object, Feature, etc.) enables common data structures to be achieved for all data sets modeled in this way, with which a universal understanding is possible. All elements represent the structure information of a data set. Applications can thus access the data or navigate within the network of objects in a uniform way. Furthermore any mapping requirements not yet currently known can be fulfilled, which are then incorporated into this basic understanding of the uniformity and can be understood by other applications. Applications which adapt to this uniform format in the future then automatically enjoy compatibility with all previous applications.

The designation of the identity of an object is never changed once created, in particular it is retained if the object is shifted within a data set or if the object is inserted into other data sets. The identity serves to uniquely identify an object, i.e. an object can be referenced absolutely via its identity, that is without reference to its environment or its context.

As well as an identity each object has a logical name. By contrast with the identity the name can be changed and also does not have to be globally unique. If however the names of the objects in each feature are unique, these can be used to form what are known as path references (reference of a object in relation to its environment).

Elements of type Feature form the substructure of the objects. They group together parameters, references, subobjects, connectors and connections of the object for example and can also themselves be structured using Features.

In accordance with an advantageous embodiment of the invention the type Object has an identification of the object type and an identification of a version of the object as further attributes. This is especially advantageous for structuring complex data sets which vary over time.

A further improved structuring of the data can be achieved if the elements linked and grouped together by an element of type Feature form a logically contiguous subset of all elements of an object. One of the bases for the grouping can be a topological association of the elements of the object to a specific view” (e.g. HMI, hardware, software) of the object. With this subdivision the relevant applications can more easily read the object data which is of interest to them. On the other hand Features can be used to expand existing objects by specific further object information which is to be added to the object and may possibly only be of interest to particular applications. This way can usefully be selected instead of expansion by derivation so that products which operate with existing types are not incompatible. Expansion by new features does not have to take account of existing applications.

Furthermore the objects can also include via features further (sub)objects and references to other objects. Aggregation thus produces a tree of objects, with cross links between the elements of this tree being able to be represented by the references. Advantageously no roles of objects are explicitly specified. The roles are represented implicitly by the position of a object in relation to other objects, or are expressed by the references from and to other objects.

If the object model is described by an extensible identification language (e.g. XML=Extensible Markup Language), systematic validation capabilities are obtained in addition to uniformity and expandability.

Usually data sets which are used in the engineering of automation systems form extensive and complex hierarchical structures. To make their structural content available in a uniform and transparent way for different applications involved, it is proposed that the inventive system or method be used for engineering an automation solution.

The invention is described and explained in more detail below on the basis of the exemplary embodiments shown in the Figures.

### BRIEF DESCRIPTION OF THE DRAWING

FIG. 1 shows the basic idea of the object model in the form an a UML diagram, and

FIG. 2 shows a system for engineering an automation solution.

### DETAILED DESCRIPTION OF THE INVENTION

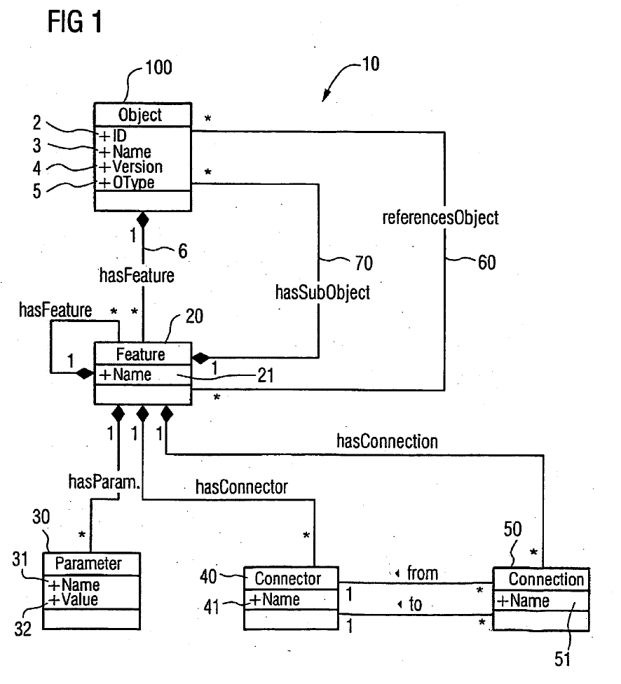

FIG. 1 shows the basic idea of the object model 10 in the form of a UML diagram. UML (=Unified Modeling Language) is a graphical language standardized by the Object Management Group (OMG) for describing object-oriented models. In the center of object model 10 is the type object 100. in the exemplary embodiment each object 100 has the attributes ID 2, OType 5, Version 4 and Name 3. ID 2 here is a unique identifier which never changes. ID 2 can for example be a GUID (=Globally Unique Identifier). It is used for unique identification of object 100, i.e. object 100 can be referenced absolutely, that is without reference to its environment or its context, via ID 2. Each object 100 is assigned a Name 3. The object 100 can also be referenced via the Name 3.

As can be seen from the diagram of FIG. 1, features 20 form the substructure of the objects 100. They group together the parameters 30, references 60, sub-objects 100, connectors 40 and connections 50 of the object 100 and can also be structured themselves using features 20. The link to the subobject 100 is identified in the UML diagram of FIG. 1 with reference symbol 70, the subobject 100 however is given the same reference symbol as the above-mentioned object 100, since it features the same structure. The basis of the grouping is one the one hand the topological association of the components of the object 100 with a specific “view” (e.g. HMI, hardware, software) of the object 100. With this subdivision the relevant tools can more easily read that object data which is of interest to them.

On the other hand features 20 form the unit of extension of objects 100 by product-specific components. Features 20 can thus be used to expand existing object types by specific further object information which is to be added to object 100 and may possibly only be of interest to particular applications. This way would be selected instead of expansion by derivation so that products which operate with existing types are not incompatible. When an object is to be expanded by data of another product, a new feature 20 will be defined, which is then added to the existing object 100. The definition of the original of type is retained in this case so that the tools which were working with the previous object will not be adversely affected. Expansion by features 20 does not have to take account of existing applications. Features 20, which have a unique name 21 in relation to the relevant object 100 queries, have 1-to-n relationships to parameters 30, connectors 40 and connections 50 in each case. Furthermore the objects 100 can also aggregate subobjects 100 via features 20 and contain references 60/relations to other objects 100. The aggregation produces a tree of objects 100. Cross-references between the elements of this tree can be represented by references 60. In graphical terms the parameters 30, connectors 40 and connections 50 represent the trunk of the tree, that is the actual data in relation to the data sets to be modeled. Features 20 can themselves again contain features 20. Objects, features and references represent the structure information of a data set.

The Identifier ID 2 of an object 100 is never changed once it has been created. In particular it is preserved if the object 100 is shifted within a data set and when the object 100 is inserted into other data sets. ID 2 is used as an absolute reference to an object 100. I.e. an object 100 can be referenced absolutely, that is without reference to its environment/its context, via ID 2. As well as an ID 2 each object 100 has a (logical) name 3. By contrast with ID 2, the name 3 can be changed and also does not have to be globally unique. If however the names 2 of the subobjects 100 in each feature 20 are unique, these can be used to form what are known as path references (references an object 100 in relation to its environment).

No roles of objects 100 are explicitly specified. Instead the roles are represented implicitly by the position of a object 100 in relation to other objects, or are expressed by the references 60 from and to other objects 100.

By using this principle of representation (object 100, feature 20, etc.) it is possible to achieve common basic structures for data sets modeled in this way, with which a universal understanding s possible, not to mention enabling applications to access the contents or navigate within the networks of objects in a uniform way. Furthermore any mapping requirements not yet currently known can be fulfilled, which are then incorporated into this basic understanding of the uniformity and can be understood by other applications. Applications which adapt to this uniform format in the future then automatically enjoy compatibility with all previous applications.

If these ideas are set down in schemas of the Meta language XML (=Extensible Markup Language) systematic validation capabilities are obtained in addition to uniformity and expandability. The above-mentioned object model 10 will be illustrated below on the basis of a representation as a schema in XML:

```
<xsd:complexType Name=“ObjectT”>
    <xsd:sequence>
      <xsd:elements name=“Features” type=“FeaturesT”
      minOccurs=“0”/>
      </xsd:sequence>
    <xsd:attribute Name=“ID” type=“IdT” use=“required”/>
    <xsd:attribute Name=“Name” type=“xsd:string” use=“required”/>
    <xsd:attribute Name=“Version” type=“VersionT” use=“optional”/>
    <xsd:attribute Name=“Type” type=“xsd:QName” use=“optional”/>
</xsd:complexType>
<xsd:complexType Name=“FeatureT” />
    <xsd:complexContent>
      <xsd:sequence>
        <xsd:elements ref=“Parameter” minOccurs=“O”/>
        <xsd:elements ref=“reference” minOccurs=“0” />
        <xsd:elements ref=“object” minOccurs=“0” />
      </xsd:sequence>
      <xsd:attribute Name=“Name” type=“xsd:string” use=“required”/>
    </xsd:complexContent>
</xsd:complexType>
<xsd:complexType Name=“ParameterT”>
    <xsd:annotation>
      <xsd:documentation>Base type for all DIA-X parameters that are
      used within features of objects</xsd:documentation>
    </xsd:annotation>
    <xsd:attribute Name=“MustUnderstand” type=“xsd:boolean”
    use=“optional” default=“false” />
    <xsd:attribute Name=“Name” type=“xsd:string” use=“optional” />
</xsd:complexType>
```

The idea underlying the invention will be explained in greater detail on the basis of a further exemplary embodiment. A symbol, as is usual for example in automation technology, is to be represented. As well as its name, such a symbol contains a type, a direction and a value. The example symbol to be presented is as follows:
S7 AO Niveau EO.3

with “S7 AO Niveau” being the name of the symbol. Type and direction are encoded together with the value in the designation EO.3 such that the “E” means the (German) direction designation for “input”, and in the period designates the addressing of a bit within a word. The example symbol would be represented as follows in accordance with the above object model 10, and would also be able to be validated if the above general schema were to be provided with the symbol-specific refinements shown below. A instance of the example symbol “S7 AO Niveau” is defined as follows as an XML schema:

```
<base:symbol ID=“{5ED19706-3840-4da0-ADD2
  27491C0A58BB}”Name=“S7 AO Niveau”>
  <base:AddressFeature>
    <base:SymbolAddress Direction=“In” AddressType=“Bit”
    Value=“3.0” />
  </base:AddressFeature>
</base:symbol>
```

The previously-mentioned symbol-specific refinements are described below, with the aid of which a symbol described in this way is able to be validated. A symbol-specific object type (called “SymbolT” here) is first to be derived from the general type “Object”. As explained above, this also contains a feature (since it is derived), namely again a symbol-specific feature. It is called

“SymbolAddressFeatureT”

```
<xsd:elements Name=“symbol” type=“symbol”
  substitutionGroup=“diax:Object”/>
<xsd:complexType Name=“symbol”>
  <xsd:complexContent>
    <xsd:extension base=“diax:ObjectT”>
      <xsd:sequence>
        <xsd:elements Name=“AddressFeature”
  type=“SymbolAddressFeatureT”/>
      </xsd:sequence>
    </xsd:extension>
  </xsd:complexContent>
</xsd:complexType>
```

This symbol-specific feature (called “SymbolAddressFeatureT”, with “T” standing for type) contains in accordance with the above base object a parameter, namely again a symbol-specific parameter called

“SymbolAddressT”

```
Feature SymbolAddressFeatureT
<xsd:complexType Name=“SymbolAddressFeatureT”>
    <xsd:complexContent>
    <xsd:extension base=“diax:FeatureT”>
      <xsd:sequence>
        <xsd:elements Name=“SymbolAddress”
  type=“SymbolAddressT”/>
      </xsd:sequence>
    </xsd:extension>
  <Ixsd:complexContent>
</xsd:complexType>
```

The symbol-specific parameter “SymbolAddress” is defined below. It contains the remaining information: data type, direction, value.

```
Parameter SymbolAddressT
<xsd:complexType Name=“SymbolAddressT”>
    <xsd:complexContent>
      <xsd:extension base=“diax:ParameterT”>
            <xsd:attribute Name=“AddressType”
    type=“AddressTypeEnumT” use=“required”/>
            <xsd:attribute Name=“Direction” type=“DirectionEnumT”
    use=“required”/>
            <xsd:attribute Name=“Value” type=“xsd: string”
    use=“required”/>
      </xsd:extension>
  </xsd:complexContent>
</xsd:complexType>
```

The ‘type’ and ‘direction’ attributes used in the address parameters are defined with further specifications. The “value” is finally only an xsd: string without restrictions. The above example symbol is suitable for the generic basic object model 10 and defined so that it can be fully validated.

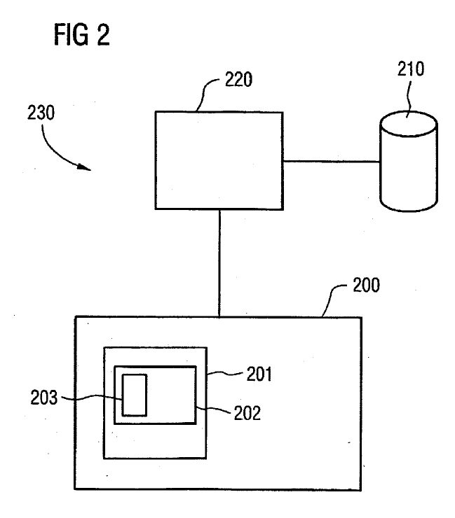

Usually data sets 210, as they occur in the engineering 220 of automation systems 230, are procured as extensive complex hierarchical structures. To make their structural content uniform and transparent for others, a simple object model 10 in accordance with invention can be defined as a central, generic basic element of representation. This will be demonstrated below using the example of a hardware project 200 with its structural layout (see FIG. 2). The hierarchical structure named “‘Project” 200 includes a processing station 201, which is designated “S7 300”. On a “Rack UR” 202 this contains a “CPU 315” 203, which contains, among numerous other symbols, the symbol “S7 AO Niveau”in its symbol container. Naturally for a validatable presentation of these structures specific refinements are necessary in their turn (for example the Structural Feature, which describes the structure of an object) but presentation of this is not included in this case. Here it is enough to note that any number of them can be generated by the corresponding derivation, with all presented data then also being systematically validatable.

```
<base:Project ID=“{3E397603-9E8C-46EC-8B41-10A6OFAA3B17}”
Name=“Project”>
  <base:StructuralFeature>
    <base:Device ID=“{EEAD7EA6-2F73-46D8-BCF2-257
    DAC712CF813}” Name=“S7300”>
        <base:StructuralFeature>
          <base:Device ID=“{E378890F-DEA9-41EF-8C35-
          6EEF76FD748B}” Name=“UR”>
            <base:StructuralFeature>
              <base:Device ID=“{85852272-12E2-4D4...}”
              Name=“CPU315”>
                <base:SoftwareFeature>
                  <base:symbol ID=“{85F306C6-412...}”
                  Name=“S7 AO Niveau”>
                    <base:AddressFeature>
                      <base:SymbolAddress Direction=“In”
    AddressType=Bit” Value=“0.3”/>
                    </base:AddressFeature>
                  </base:symbol>
...
```

In summary the invention thus relates to a system as well as to a method for structuring, storage and processing of data. Exchange of data between various software applications is simplified by the structuring, storage and processing in accordance with a generic object model 10, with the object model 10 featuring at least one first element which corresponds to a type Object 100, with the type Object 100 having the following attributes:

a unique identification 2 of the object for absolute referencing of the object 100,

a logical name 3 to label the object 100 and

at least one link 6 to a second element, which corresponds to a type Feature 20, with the type Feature 20 having the following attributes:
a unique name 21 in relation to the relevant linked object 100 referenced and

the option of linkage to further components of type Object 100, to further components of type Feature 20 and to data 30, 40, 50.

1.-7. (canceled)

8. a system for structuring, storing and processing of data in accordance with a generic object model, wherein the object model has at least one first element which corresponds to a type object, wherein the type object comprises the following attributes:
a unique identification of an object of the type Object for absolute referencing of the object,
a logical name for labeling the object, and
at least one link to a second element, which corresponds to a type Feature, wherein the type Feature comprises the following attributes:
a unique name in relation to the object, and
the option of linkage to further components of the type Object, to further components of the type Feature, and to data.

9. The system in accordance with claim 8, wherein the type Object has as further attributes an identification of the object type and an identification of the version of the object.

10. The system in accordance with claim 8, wherein elements linked by an element of type Feature form a logical subset of all elements of an object.

11. The system in accordance with claim 9, wherein elements linked by an element of type Feature form a logical subset of all elements of an object.

12. The system in accordance with claim 8, wherein the elements of the object are linked by references.

13. The system in accordance with claim 9, wherein the elements of the object are linked by references.

14. The system in accordance with claim 10, wherein the elements of the object are linked by references.

15. The system in accordance with claim 8, wherein the object model is described by an extensible markup language.

16. The system in accordance with claim 15, wherein the object model is described by an extensible markup language.

17. The system in accordance with claim 9, wherein the object model is described by an extensible markup language.

18. The system in accordance with claim 10, wherein the object model is described by an extensible markup language.

19. The system in accordance with claim 12, wherein the object model is described by an extensible markup language.

20. The system in accordance with claim 8, wherein the system is part of an engineering system of an automation system.

21. A method for structuring, storing and processing data in accordance with a generic object model, wherein the object model has at least one first element corresponding to the type Object, wherein the type Object comprises the following attributes:
a unique identification of an object of the type Object for absolute referencing of the object,
a logical name for labeling the object, and
at least one link to a second element, which corresponds to a type Feature, the method comprising:
assigning a unique identification to an instance of the type Object for absolute referencing the instance;
assigning a logical name for labeling the instance; and
linking the instance to the second element, wherein the type Feature comprising the following attributes:
a unique name in relation to the relevant linked object referenced, and
the option of linkage to further components of the type Object, to further components of the type Feature, and to data.

22. The method in accordance with claim 21, wherein the data are structured, stored, and processed for engineering an automation system.

23. A method for structuring, storing and processing of data in accordance with a generic object model, wherein the object model has at least one first element which corresponds to the type Object, the method comprising:
providing a unique identification of an object of the type Object for absolute referencing of the object;
providing a logical name for labeling the object; and
linking the object to a second element, which corresponds to a type Feature, wherein the type Feature comprising:
a unique name in relation to the linked object, and
the option of linkage to further components of type Object, to further components of type Feature and to data.

24. The method in accordance with claim 23, wherein the data are structured, stored, and processed for engineering an automation system.
